(19) United States
(12) Patent Application Publication
(10) Pub. No.: US 2008/0214137 A1
(43) Pub. Date: Sep. 4, 2008

(54) Receiver For Wireless Communications

(76) Inventor: Xuecheng Qian, Shanghai (CN)

Correspondence Address: PHILIPS INTELLECTUAL PROPERTY & STANDARDS, PO BOX 3001, BRIARCLIFF MANOR, NY, 10510-8001, US

(21) Appl. No.: 10/581,805

(22) PCT Filed: Nov. 15, 2004
(86) PCT No.: PCT/IB04/52415

§ 371 Date: Jun. 2, 2006

(30) Foreign Application Priority Data
Dec. 5, 2003 (CN) 20031012252

(51) Int. Cl. H04B 1/10

(52) U.S. Cl. 455/307

(57) ABSTRACT

An RF filtering and amplifying apparatus is proposed, comprising: a plurality of RF filters, connected with each other in a manner of cascade, for filtering the received radio signal level by level; a LNA (low noise amplifier), for amplifying the filtered signal to output an amplified and filtered signal. The RF filtering and amplifying apparatus in the present invention can not only meet the requirement for the selectivity of the filters, but also achieve desirable in-band distortion and insertion loss meanwhile.

### FIELD OF THE INVENTION

The present invention relates generally to a bandpass sampling receiver for use in wireless communication systems, and more particularly, to a bandpass sampling receiver whose RF circuit is constructed by multiple cascaded RF filters.

### BACKGROUND ART OF THE INVENTION

Receivers play a important role in wireless communications, receiving RF signal from radio space at the antenna and converting it into baseband digital signal centered to zero frequency so that the desired user signal satisfying the BER (Bit Error Rate) requirement can be recovered through further baseband processing.

FIG. 1 displays a widely used conventional super heterodyne receiver. As FIG. 1 shows, antenna unit 10 sends the receive d analog RF signal to RF filter 20. RF filter 20 bandpass filters the analog RF signal so that the portion of the analog RF signal in the frequency band of the user signal can pass whilst the out-of-band interference far away from the frequency band of the user signal is suppressed. Then, the bandpass filtered analog RF signal is sent to LNA (low noise amplifier) 30. LNA 30 amplifies the bandpass filtered analog RF signal and outputs it to the first mixer 40. In the first mixer 40, the analog RF signal from LNA 30 is multiplied with the LO (Local Oscillator) signal with frequency of f₁ generated by LO 50, to be converted into analog IF (Intermediate Frequency) signal and outputted to IF filter 60. After receiving the analog IF signal from the first mixer 40, IF filter 60 further attenuates the out-of-band interference and outputs it to AGC (automatic gain control) 70. AGC 70 tunes the analog IF signal from IF filter 60 within a suitable dynamic range, and outputs the tuned analog IF signal to two processing paths for processing.

In the first processing path, the second mixer 80 multiplies the analog IF signal from AGC 70 by the second LO signal with frequency of f₂ generated by LO 90, to convert it into analog baseband signal, and then sends the analog baseband signal to lowpass filter 100. After receiving the analog baseband signal from the second mixer 80, lowpass filter 100 further removes the out-of-band interference out of the analog baseband signal and outputs it to AGC 120. AGC 120 performs relevant processing on the analog baseband signal from lowpass filter 100, and then sends it to ADC (analog-to-digital converter) 140. After receiving the analog baseband signal from AGC 120, ADC 140 samples and quantizes the signal to get the digital baseband in-phase signal and outputs it to DSP (digital signal processing) unit 160.

In the second processing path, the second mixer 105 multiplies the analog IF signal from AGC 70 by the second LO signal with frequency of f₂ generated by LO 90 and phase shifted by 90°, to convert it into analog baseband signal, and then sends the analog baseband signal to lowpass filter 110. After receiving the analog baseband signal from the second mixer 105, lowpass filter 110 further removes the out-of-band interference out of the analog baseband signal and outputs it to AGC 130. AGC 130 performs relevant processing on the analog baseband signal from lowpass filter 110, and sends it to ADC 150. After receiving the analog baseband signal from AGC 130, ADC 150 samples and quantizes the signal to get the digital baseband quadrature signal and outputs it to DSP unit 160.

After receiving the digital baseband in-phase signal from ADC 140 in the first processing path and the digital baseband quadrature signal from ADC 150 in the second processing path, DSP unit 160 processes them by using relevant digital signal processing techniques to recover the wanted user signal.

The above section describes the conventional baseband sampling receiver. The conventional receiver performs most processing work o n RF signals in analog domain, and thus can't adopt many state-of-the-art DSP techniques in digital domain. To overcome this deficiency, a receiver is proposed to sample analog RF signals directly, and this is the so-called bandpass sampling receiver. The sampling frequency of the bandpass sampling receiver is substantially lower than the carrier frequency, so it is also called as sub-sampling receiver.

FIG. 2 is a block diagram illustrating the bandpass sampling receiver. As FIG. 2 shows, antenna unit 170 receives analog RF signal within a wide band range and sends it to RF filter 180. After receiving the analog RF signal from antenna unit 170, RF filter 180 filters the analog RF signal through bandpass filtering to get an analog RF signal with frequency band as Bᵢ, and then sends the analog RF signal with frequency band as Bᵢ to LNA 190. LNA 190 amplifies the analog RF signal from RF filter 180 and outputs it to ADC unit 200. After receiving the analog RF signal from LNA 190, ADC unit 200 samples and quantizes the analog RF signal with a sampling clock at frequency of fₛ, to convert it into digital signal and outputs the digital signal to DSP unit 210. DSP unit 210 processes the digital signal from ADC unit 200 by using relevant digital signal processing techniques, to recover the wanted user signal.

It can be seen that bandpass sampling receivers perform most processing work on the received signals in digital domain. The processing work can be implemented in flexible software or hardware, and the same modules can also be used to support multi-band and multi-mode operations.

In many communication systems, the received desired user signal only allows for very small distortion. When the analog RF signal received at the antenna is bandpass sampled by the bandpass sampling receiver, the out-of-band interference out of the frequency band of the desired user signal will fold into the frequency band of the user signal and cause distortion in the user signal. The power of said out-of-band interference is usually very strong, so the distortion caused in the user signal often exceeds the allowable level. To address this problem, bandpass sampling receivers have to use RF filters with high selectivity, so that the RF signal in the frequency band of the user signal is filtered out whilst the out-of-band interference out of the frequency band of the user signal is greatly suppressed.

GSM will be exemplified below to describe the requirement for high selectivity of RF filters, in conjunction with FIG. 3. As shown in FIG. 3, GSM900 occupies a frequency band from 925 MHz to 960 MHz and the bandwidth is 35 MHz, and for noises ±20 MHz from each edge of the frequency band, the receiver requires an attenuation of 106 dB. Assuming the Nyquist sampling frequency as 200 MHz (it's a rather high value for sampling one channel), the bandwidth of the input signal at the ADC unit shall be less than 100 MHz. Assuming that the bandwidth Bᵢ of the input signal is 100 MHz, all interference more than (Bᵢ−35)/2=(100−35)/2=32.5 MHz away from the edge of the GSM system signal band should be attenuated by no less than 106 dB. By using a technique of two-path bandpass sampling, the bandwidth Bᵢ of the input signal at the ADC unit could be equal to the sampling frequency 200 MHz. In this situation, all interference more than (Bᵢ−35)/2=(200−35)/2=82.5 MHz away from the edge of the GSM system signal band should be attenuated by 106 dB. However, it's still extremely difficult for a n RF filter to have such a high selectivity with ideal in-band distortion and reasonable component size at acceptable cost. Therefore, application of bandpass sampling at radio frequency is very limited and exists mainly in theoretical analysis.

### SUMMARY OF THE INVENTION

An object of the present invention is to provide a bandpass sampling receiver for use in mobile communication systems. In this bandpass sampling receiver, the analog RF signal received at the antenna is filtered by an RF processing link constructed by multiple cascaded RF filters, thus the bandpass sampling receiver can satisfy the requirement for selectivity, and attain ideal in-band distortion, insertion loss, component size and cost as well.

Another object of the present invention is to provide a bandpass sampling receiver for use in mobile communication systems. In this bandpass sampling receiver, the analog RF signal received at the antenna is filtered by multiple RF processing links operating in different bands and individually constructed by multiple cascaded RF filters, thus the bandpass sampling receiver can satisfy the selectivity requirement when working in multi-band and multi-mode or wide frequency band.

The third object of the present invention is to provide a bandpass sampling receiver for use in mobile communication systems. In this bandpass sampling receiver, the analog RF signal received at the antenna is filtered by a tunable RF processing link constructed by multiple cascaded RF filters, thus the bandpass sampling receiver can satisfy the selectivity requirement when working in multi-band and multi-mode or wide frequency band.

An RF filtering and amplifying apparatus is proposed in the present invention, comprising: a plurality of RF filters, cascade connected with each other, for filtering the received radio signal level by level; a LNA (low noise amplifier), for amplifying the filtered signal to output an amplified and filtered signal.

An RF filtering and amplifying apparatus is proposed in the present invention, comprising: a control unit, for generating a control signal according to the frequency band of the received radio signal; a plurality of RF processing modules, corresponding to a plurality of radio links, each RF processing module for filtering and amplifying the radio signal in the corresponding frequency band to output an amplified and filtered signal in the corresponding frequency band; a front-end band switching unit, for switching the received radio signal in the corresponding frequency band to the RF processing module in the corresponding frequency band of said plurality of RF processing modules, according to the control signal; a back-end band switching unit, for switching to the RF processing module in the corresponding frequency band according to the control signal, so as to receive the amplified and filtered signal in the corresponding frequency band outputted from the RF processing module.

### BRIEF DESCRIPTION OF THE DRAWINGS

FIG. 1 is a schematic diagram illustrating a widely used conventional super heterodyne receiver;

FIG. 2 is a block diagram illustrating existing bandpass sampling receivers;

FIG. 3 displays the curve chart illustrating the selectivity requirement of existing GSM systems;

FIG. 4 illustrates the bandpass sampling receiver employing a plurality of cascaded RF filters in an embodiment of the present invention;

FIG. 5 illustrates the proposed bandpass sampling receiver in which a LNA is inserted between two adjacent cascaded RF filters in one embodiment of the present invention;

FIG. 6 is a schematic diagram illustrating the multi-band and multi-mode;

FIG. 7 illustrates the separation of one wide frequency band into multiple narrow sub-bands;

FIG. 8 is a block diagram illustrating the bandpass sampling receiver employing a plurality of RF processing links in one embodiment of the present invention;

FIG. 9 is a block diagram illustrating the bandpass sampling receiver employing a tunable RF processing link in one embodiment of the present invention;

FIG. 10 is a block diagram illustrating the bandpass sampling receiver employing a front-placed tunable RF processing link in one embodiment of the present invention;

FIG. 11 is a block diagram illustrating the bandpass sampling receiver employing a back-placed tunable RF processing link in one embodiment of the present invention;

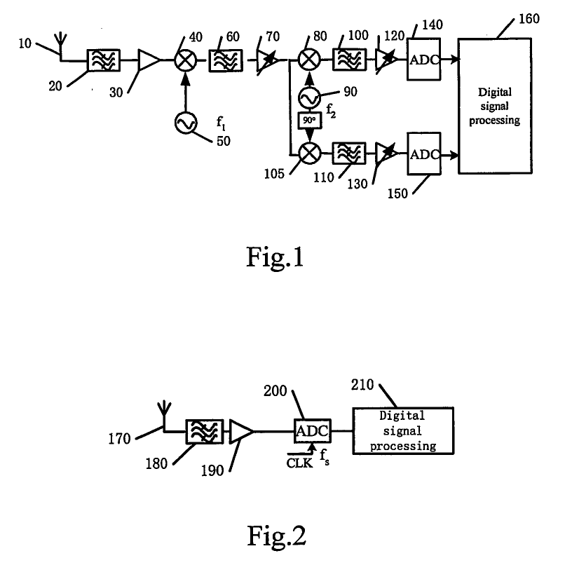

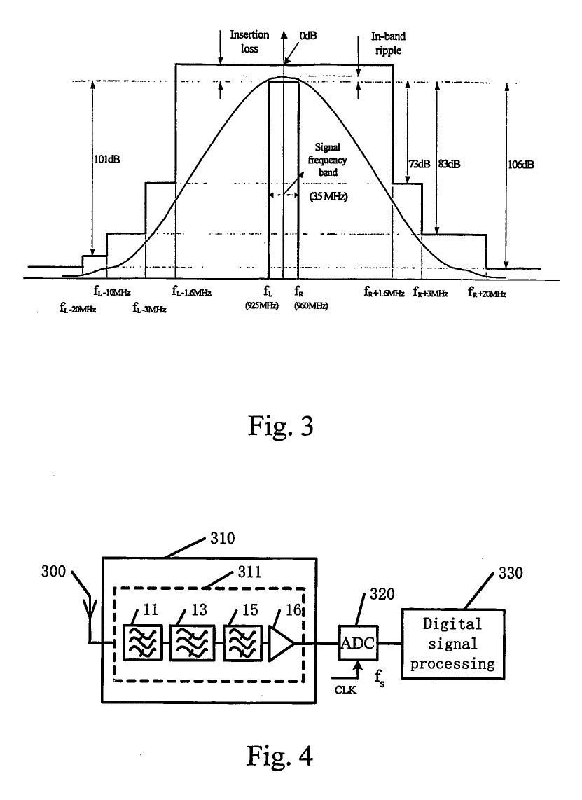

### DETAILED DESCRIPTION OF THE INVENTION

To satisfy the selectivity requirement for the RF filters of the bandpass sampling receiver, a method in an embodiment of the present invention is to adopt N cascaded RF filters with the same selectivity. Assumed that the required total attenuation of the out-of-band interference is A₀, if each RF filter can attenuate the interference by A₀/N, N cascaded RF filters can totally attenuate the out-of-band interference by A₀.

FIG. 4 illustrates the proposed bandpass sampling receiver with a plurality of cascaded RF filters. As shown in the figure, RF filtering and amplifying unit 310 of the bandpass sampling receiver is composed of an RF processing link 311, and the RF processing link 311 comprises cascaded RF filters 11, 13, 15 and LNA 16. When the bandpass sampling receiver starts to work, antenna unit 300 receives analog RF signal from the radio medium and sends it to RF processing link 311 in RF filtering and amplifying unit 310. In RF processing link 311, the analog RF signal from antenna unit 300 is first bandpass filtered by RF filters 11, 13 and 15 to attenuate the out-of-band interference, and then amplified by LNA 16 and outputted to ADC unit 320. After receiving the analog RF signal from RF processing link 311, ADC unit 320 samples and quantizes the received analog RF signal to convert it into digital signal and outputs it to DSP unit 330. DSP unit 330 processes the digital signal from ADC unit 320 by using relevant existing DSP techniques.

In general, on the premise that the total selectivity is unchanged, the more RF filters are cascaded, the lower selectivity requirement each RF filter will have. But every RF filter will introduce some in-bind distortion, and cause some insertion loss and increase in cost. Hence, with increase of cascaded RF filters, the total in-band distortion and insertion loss will increase, and the cost will be higher. Fortunately, a practical selectivity requirement can usually be fulfilled with cascade of only 2˜4 RF filters. For example, attenuation of −106 dB at 90 MHz from the edge of GSM900 signal band can be achieved with only two SAW RF filters in cascade, such as device 855966 from SAWTEK Inc.

It can be seen that cascaded RF filters will bring insertion loss. To lower the increase of noise figure caused by insertion loss of RF filters, we can insert a LNA between two adjacent RF filters. In this case, different RF filters can be used for the ones before and after the LNA. Provided that the overall selectivity is fulfilled, RF filter of less insertion loss is used in front of RF filters of relatively higher insertion loss.

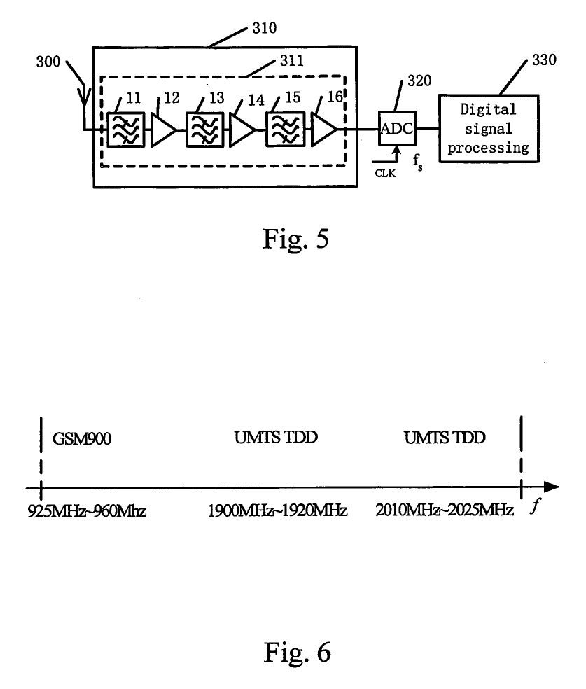

FIG. 5 illustrates the proposed bandpass sampling receiver in which a LNA is inserted between two adjacent cascaded RF filters. As shown in the figure, in RF processing link 311, LNAs 12 and 14 are inserted between RF filters 11 and 13 and between RF filters 13 and 15 respectively. When the bandpass sampling receiver begins to work, antenna unit 300 receives analog RF signal from the radio medium and sends it to RF processing link 311 in RF filtering and amplifying unit 310. In RF processing link 311, RF filter 11, LNA 12, RF filter 13, LNA 14, RF filter 15 and LNA 16 in turn will bandpass filter and amplify the analog RF signal level by level, and output it to ADC unit 320. After receiving the analog RF signal from RF processing link 311, ADC unit 320 samples and quantizes the analog RF signal to convert it into digital signal, and outputs the digital signal to DSP unit 330. DSP unit 330 processes the digital signal from ADC unit 320 by using relevant existing DSP techniques.

Most of the signal processing work of the bandpass sampling receiver can be done by software in digital domain, so the bandpass sampling receiver is very suitable for the situation of multi-band and multi-mode. As FIG. 6 shows, the bandpass sampling receiver can be applicable to GSM900 mode in band (925 MHz, 960 MHz), . . . , UMTS TDD mode in band (1900 MHz, 1920 MHz) and UMTS TDD mode in band (2010 MHz, 2025 MHz). Additionally, the bandpass sampling receiver can also work in very wide frequency band. However, it's usually very difficult for the RF processing link (shown in FIG. 4 and FIG. 5) to cover all frequency bands in the multi-band and multi-mode whilst fulfill the selectivity requirement of each frequency band.

To settle the above problem, three different bandpass sampling receivers are proposed in the present invention.

1. Bandpass Sampling Receiver Employing Multiple RF Processing Links Operating in Different Bands

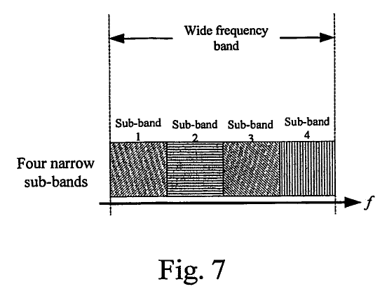

When the bandpass sampling receiver operates in multi-band and multi-mode, every RF processing link (equivalent to an RF processing module) is used for satisfying the selectivity requirement in one frequency band. When the bandpass sampling receiver operates in wide frequency band as shown in FIG. 7, the frequency band is first separated into several continuous narrow sub-bands (for example, sub-bands 1, 2, 3 and 4), and each RF processing link is used for satisfying the selectivity requirement of one sub-band thereof.

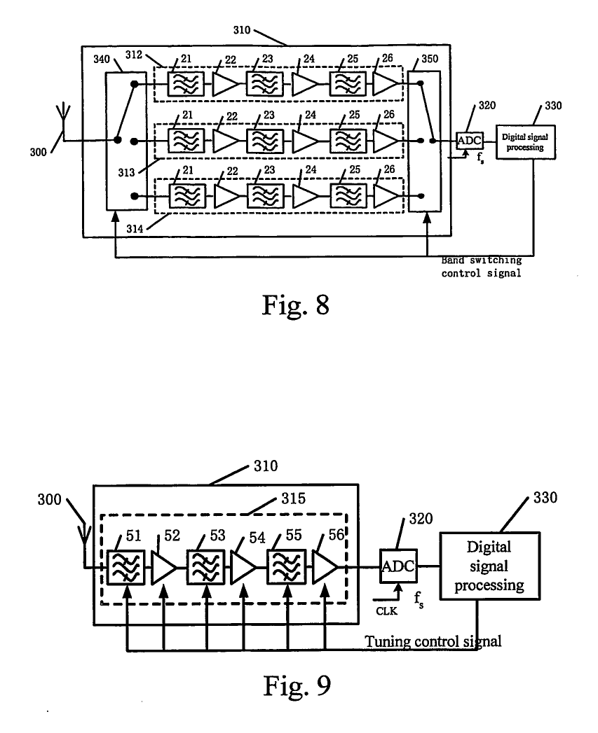

FIG. 8 is a block diagram illustrating the bandpass sampling receiver employing a plurality of RF processing links. As the figure shows, RF filtering and amplifying unit 310 is composed of three RF processing links 312, 313 and 314 operating in different frequency bands.

When the bandpass sampling receiver begins to work, first, a control unit, such as DSP unit 330, sends band switching control signal to front-end band switching unit 340 and back-end band switching unit 350, according to the corresponding frequency band of the received radio signal, to notify them to select their individual operating band. Then, antenna unit 300 receives the analog RF signal from the radio medium and sends it to front-end band switching unit 340. After receiving the analog RF signal from antenna unit 300, front-end band switching unit 340 sends the received analog RF signal to the RF processing link working in corresponding frequency band in RF filtering and amplifying unit 310, according to the band switching control signal from DSP unit 330.

In RF filtering and amplifying unit 310, if RF processing link 312 receives the analog RF signal from front-end band switching unit 340, RF filter 21, narrowband LNA 22, RF filter 23, narrowband LNA 24, RF filter 25 and narrowband LNA 26 will process the analog RF signal in turn, to filter out and amplify the signal in the operating band of the RF processing link, and output it to back-end band switching unit 350. If RF processing link 313 or RF processing link 314 receives the analog RF signal from front-end band switching unit 340, functions similar to RF processing link 312 will be executed respectively.

After receiving the analog RF signal outputted from each RF processing link operating in different frequency band in RF filtering and amplifying unit 310, back-end band switching unit 350 sends the analog RF signal outputted from the RF processing link operating in the corresponding frequency band to ADC unit 320, according to the band switching control signal from DSP unit 330. After receiving the analog RF signal from back-end band switching unit 350, ADC unit 320 converts the analog RF signal into digital signal through sampling and quantization and outputs the digital signal to DSP unit 330. After receiving the digital signal from ADC unit 320, DSP unit 330 performs relevant digital signal processing on the digital signal.

Referring to the bandpass sampling receiver shown in FIG. 8, in each RF processing link, the narrowband LNA between adjacent RF filters can be omitted if needed. Additionally, all narrowband LNAs at the corresponding location of each RF processing link can be replaced with a broadband LNA. For example, narrowband LNAs 22, 32 and 42 can be replaced with a broadband LNA. The broadband LNA receives and amplifies the filtered signal from the RF processing link in the corresponding frequency band, and provides the filtered and amplified signal to next-stage RF filter in the RF processing link in the corresponding frequency band. Similarly, narrowband LNAs 24, 34, 44 and narrowband LNAs 26, 36 and 46 can also be replaced by a broadband LNA respectively.

2. Bandpass Sampling Receiver Employing a Tunable RF Processing Link

When the bandpass sampling receiver works in multi-band and multi-mode, its RF processing link can choose to work in different bands through tuning its operating band. When the bandpass sampling receiver works in wide frequency band, its RF processing link can choose to work in different sub-bands through tuning its operating band.

FIG. 9 is a block diagram illustrating the bandpass sampling receiver employing a tunable RF processing link. As the figure shows, RF filtering and amplifying unit 310 is composed of tunable RF processing link 315, and the RF processing link 315 comprises tunable RF filters 51, 53, 55 and tunable narrowband LNAs 52, 54, 56.

When the bandpass sampling receiver begins to work, first, DSP unit 330 sends tuning control signal to RF processing link 315, to notify RF processing link 315 of the operating band. Then, antenna unit 300 receives the analog RF signal from the radio medium and sends it to RF filtering and amplifying unit 310.

In RF filtering and amplifying unit 310, after receiving the analog RF signal from antenna unit 300, RF processing link 315 first tunes RF filters 51, 53, 55 and narrowband LNAs 52, 54, 56 to the corresponding operating band, according to the tuning control signal from DSP unit 330, and then uses the tuned RF filters 51, 53, 55 and narrowband LNAs 52, 54, 56 to process the analog RF signal from antenna unit 300, to filter out and amplify the signal in the operating band of the RF processing link and output it to ADC unit 320.

After receiving the analog RF signal from RF filtering and amplifying unit 310, ADC unit 320 converts the analog RF signal into digital signal through sampling and quantization, and outputs the digital signal to DSP unit 330. After receiving the digital signal from ADC unit 320, DSP unit 330 performs relevant digital signal processing on the digital signal.

Referring to the bandpass sampling receiver as shown in FIG. 9, in its RF processing link, the LNA between adjacent RF filters can be omitted if needed. Additionally, all narrowband LNAs inserted between adjacent RF filters can be replaced with a broadband LNA. For example, narrowband LNAs 52, 54 and 56 can be replaced with a broadband LNA respectively.

3. Bandpass Sampling Receiver Employing a Tunable RF Processing Link and a Plurality of RF Processing Links Working in Different Frequency Bands

In the bandpass sampling receiver, its RF filtering and amplifying unit 310 is composed of a tunable RF processing link and a plurality of R F processing links working in different frequency bands in cascade, wherein the tunable RF processing link can be located before or behind said each RF processing link working in different frequency band.

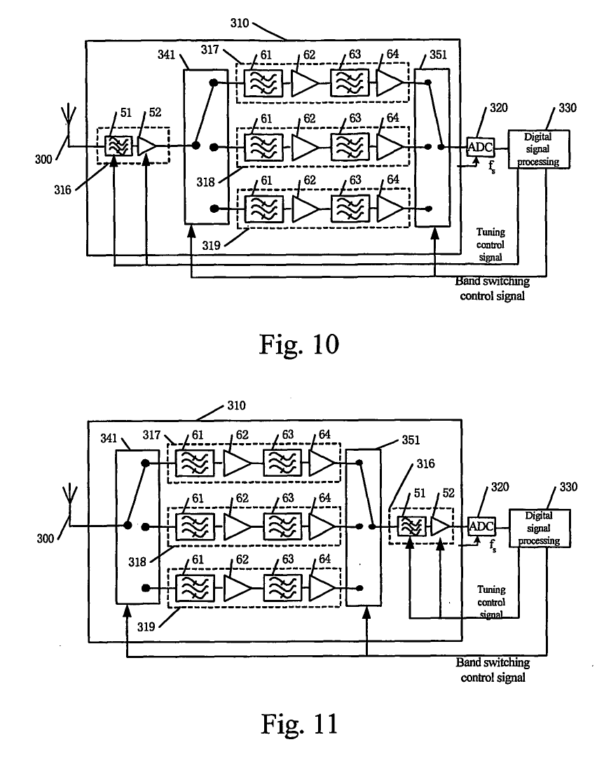

FIG. 10 is a block diagram illustrating the bandpass sampling receiver employing a front-placed tunable RF processing link in an embodiment of the present invention. As the figure shows, first, DSP unit 330 sends tuning control signal to RF processing link 316 and band switching control signals to front-end band switching units 341 and 351, to notify RF processing link 316, front-end band switching units 341 and 351 of their operating bands. Then, antenna 300 receives the analog RF signal from the radio medium and outputs it to RF filtering and amplifying u nit 310.

In RF filtering and amplifying unit 310, after the analog RF signal from antenna unit 300 is received, RF processing link 316 first tunes RF filter 51 and narrowband LNA 52 to the corresponding operating band according to the tuning control signal from DSP unit 330, then uses the tuned RF filter 51 and narrowband LNA 52 to process the received analog RF signal to filter out and amplify the signal in the operating band of the RF processing link, and outputs it to front-end band switching unit 341. After receiving the analog RF signal from RF processing link 316, front-end band switching unit 341 switches to output the analog RF signal to the RF processing link working in the corresponding frequency band according to the band switching control signal from DSP unit 330. If RF processing link 317 receives the analog RF signal from front-end band switching unit 341, RF filter 61, narrowband LNA 62, RF filter 63 and narrowband LNA 64 process the received analog RF signal in turn, to filter out and amplify the signal in the operating band of the RF processing link, and output it to back-end band switching unit 351. If RF processing 318 or 319 receives the analog RF signal from back-end band switching unit 341, it will execute the functions similar to RF processing link 317. After receiving the analog RF signals outputted from RF processing links 317, 318 and 319, back-end band switching unit sends the analog RF signal outputted from the RF processing link working in the corresponding frequency band to ADC unit 320, according to the band switching control signal from DSP unit 330.

After receiving the analog RF signal from RF filtering and amplifying unit. 310, ADC unit 320 converts the analog RF signal into digital signal through sampling and quantization, and outputs the digital signal to DSP unit 330. After DSP unit 330 receives the digital signal from ADC unit 320, it will perform relevant digital signal processing on the digital signal.

FIG. 11 is a block diagram illustrating the bandpass sampling receiver employing a back-placed tunable RF processing link thereinafter. Different from FIG. 10, the module corresponding to RF processing link 316 is placed behind back-end band switching unit 351. After receiving the RF signal outputted from back-end band switching unit 351, it tunes to the corresponding operating band according to the tuning control signal from DSP unit 330, to filter out and amplify the signal in the operating band of the RF processing link, and provide it to ADC unit 320.

Wherein, front-end band switching unit 341, RF processing link 317, RF processing link 318, RF processing link 319, back-end band switching unit 351, RF processing link 316, ADC unit 320 and DSP unit 330 all performs similar functions as their counterparts (part with the same symbol identification) as shown in FIG. 10.

Referring to the bandpass sampling receiver as shown in FIG. 10 and FIG. 11, narrowband LNA 52 in the RF processing link can be replaced with a broadband LNA, narrowband LNAs 62, 72 and 82 can be replaced with a broadband LNA, and the same goes with narrowband LNAs 64, 74 and 84.

### BENEFICIAL RESULTS OF THE INVENTION

As described above, with regard to the proposed bandpass sampling receiver for use in wireless communication systems, we use an RF processing link constructed by a plurality of cascaded RF filters with the same selectivity. The bandpass sampling receiver can not only meet the selectivity requirement, but also achieve ideal in-band distortion, insertion loss, architecture size and cost. Moreover, insertion loss can be further minimized through inserting LNA between adjacent cascaded RF filters.

Furthermore, with regard to the proposed bandpass sampling receiver for use in wireless communication systems, we use a tunable RF processing link constructed by a plurality of cascaded RF filters, or use a plurality of RF processing links, each of which works in different frequency band and is constructed by a plurality of RF cascaded RF filters, or use a tunable RF processing link and a plurality of RF processing links working in different frequency bands, to filter the analog RF signal received by the antenna. Therefore, the proposed bandpass sampling receiver can work in multi-band and multi-mode, or in wide frequency band, and satisfy the selectivity requirement as well.

It is to be understood by those skilled in the art that the bandpass sampling receiver for use in wireless communication systems as disclosed in this invention can be modified considerably without departing from the spirit and scope of the invention as defined by the appended claims.

1. An RF filtering and amplifying apparatus, comprising:
a plurality of RF filters, connected with each other in a manner of cascade, for filtering the received radio signal level by level;
a LNA (low noise amplifier), for amplifying the filtered signal to output an amplified and filtered signal.

2. The apparatus according to claim 1, further comprising:
a control unit, for generating a control signal according to the frequency band of the received radio signal;
wherein:
each of said plurality of RF filters tunes to the corresponding operating band to filter the radio signal in the receive frequency band level by level;
said LNA tunes to the corresponding operating band according to the control signal, to amplify the filtered signal in the corresponding frequency band, so as to output an amplified and filtered signal in the corresponding frequency band.

3. The apparatus according to claim 1, further comprising:
a plurality of LNAs, each located between two adjacent RF filters of said plurality of RF filters, for amplifying the signal outputted by the RF filter in front of said LNA.

4. The apparatus according to claim 2, further comprising:
a plurality of LNAs, each located between two adjacent RF filters of said plurality of RF filters, and tuning to the corresponding operating band according to said control signal, so as to amplify the signal in the corresponding frequency band outputted by the RF filter in front of said LNA.

5. The apparatus according to claim 3, wherein each of said plurality of RF filters has different selectivity.

6. The apparatus according to claim 3, wherein the cascade mode adopted by said plurality of RF filters is to place RF filters with less insertion loss in front of RF filters with relatively higher insertion loss.

7. An RF filtering and amplifying apparatus, comprising:
a control unit, for generating a control signal according to the frequency band of the received radio signal;
a plurality of RF processing modules, corresponding to a plurality of radio links, wherein each RF processing module filters and amplifies the radio signal in the corresponding frequency band to output an amplified and filtered signal in the corresponding frequency band;
a front-end band switching unit, for switching the received radio signal in the corresponding frequency band to the RF processing module in the corresponding frequency band of the plurality of RF processing modules, according to the control signal;
a back-end band switching unit, for switching to the RF processing module in the corresponding frequency band, so as to receive the amplified and filtered signal in the corresponding frequency band outputted from the RF processing module.

8. The apparatus according to claim 7, wherein each of said RF processing modules includes:
a plurality of RF filters, connected with each other in a manner of cascade, for filtering the received radio signal level by level;
a LNA, for amplifying the filtered signal to output an amplified and filtered signal.

9. The apparatus according to claim 8, further comprising:
a plurality of LNAs, each of which is located between two adjacent RF filters of said plurality of RF filters, for amplifying the signal outputted by the RF filter in front of the LNA.

10. The apparatus according to claim 9, wherein each of said plurality of RF filters has different selectivity.

11. The apparatus according to claim 9, wherein the cascade mode adopted by said plurality of RF filters is to place RF filters with less insertion loss in front of RF filters with relatively higher insertion loss.

12. The apparatus according to claim 9, wherein at least two LNAs behind the RF filters at the same level in at least two RF processing modules of said plurality of RF processing modules, form a LNA, and the formed LNA amplifies the filtered signal of the RF filters from the RF processing modules in the corresponding frequency band, and provides the amplified signal to the RF filters at next level in the RF processing module in the corresponding frequency band.

13. The apparatus according to claim 12, further comprising: a tunable RF processing module, for filtering and amplifying the received radio signal in the corresponding frequency band according to said control signal, and providing the amplified and filtered signal in the corresponding frequency band to said front-end band switching unit.

14. The apparatus according to claim 13, wherein said tunable RF processing module includes:
at least one RF filter, for filtering the received radio signal in the corresponding frequency band according to said control signal;
at least one LNA, for amplifying the filtered signal to output an amplified and filtered signal in the corresponding frequency band.

15. The apparatus according to claim 12, further comprising:
a tunable RF processing module, for receiving the output signal in the corresponding frequency band from said back-end band switching unit according to said control signal, and filtering and amplifying the output signal in the corresponding frequency band.

16. The apparatus according to claim 15, wherein said tunable RF processing module includes:
at least one RF filter, for filtering the output signal in the corresponding frequency band from said back-end band switching unit, according to said control signal;
at least one LNA, for amplifying the filtered signal to output an amplified and filtered signal in the corresponding frequency band.

17. An apparatus for receiving radio signal, comprising:
a receiving unit, for receiving radio signal;
an RF filtering and amplifying unit, for filtering the received radio signal level by level, and amplifying the filtered signal;
an ADC, for analog-to-digital converting the amplified and filtered signal to get a digital signal;
a digital signal processing unit, for processing the digital signal.

18. The apparatus for receiving radio signal according to claim 17, wherein said RF filtering and amplifying unit includes:
a plurality of RF filters, connected with each other in a manner of cascade, for filtering the received radio signal level by level;
a LNA, for amplifying the filtered signal to output an amplified and filtered signal.

19. The apparatus for receiving radio signal according to claim 18, wherein:
said digital signal processing unit, generates a control signal according to the frequency band of the received radio signal;
each of said plurality of RF filters, tunes to the corresponding operating band according to the control signal, to filter the radio signal in the receive frequency band level by level;
said LNA, tunes to the corresponding operating band according to the control signal, to amplify the filtered signal in the corresponding frequency band, thus outputs an amplified and filtered signal in the corresponding frequency band.

20. The apparatus for receiving radio signal according to claim 18, further comprising:
a plurality of LNAs, each of which is located between two adjacent RF filters of said plurality of RF filters, for amplifying the signal outputted by the RF filter in front of the LNA.

21. The apparatus for receiving radio signal according to claim 19, further comprising:
a plurality of LNAs, each of which is located between two adjacent RF filters of said plurality of RF filters, for tuning to the corresponding operating band according to said control signal, to amplify the signal in the corresponding frequency band outputted by the RF filter in front of the LNA.

22. The apparatus for receiving radio signal according to claim 17, wherein:
said digital signal processing unit, for generating a control signal according to the frequency band of the received radio signal;
said RF filtering and amplifying unit, comprising:
a plurality of RF processing modules, each of which filters and amplifies the radio signal in the corresponding frequency band, to output an amplified and filtered signal in the corresponding frequency band;
a front-end band switching unit, for switching the received radio signal in the corresponding frequency band to the RF processing module in the corresponding frequency band in said plurality of RF processing modules, according to the control signal;
a back-end band switching unit, for switching to the RF processing module in the corresponding frequency band according to the control signal, so as to receive the amplified and filtered signal in the corresponding frequency band outputted from the RF processing module.

23. The apparatus for receiving radio signal according to claim 22, wherein each of said RF processing module includes:
a plurality of RF filters, connected with each other in a manner of cascade, for filtering the received radio signal level by level;
a LNA, for amplifying the filtered signal to output an amplified and filtered signal.

24. The apparatus for receiving radio signal according to claim 23, further comprising:
a plurality of LNAs, each of which is located between two adjacent RF filters of said plurality of RF filters, for amplifying the signal outputted by the RF filter in front of the LNA.

25. The apparatus for receiving radio signal according to claim 24, further comprising:
a tunable RF processing module, for filtering and amplifying the received radio signal in the corresponding frequency band according to said control signal, and providing the amplified and filtered signal in the corresponding frequency band to said front-end band switching unit.

26. The apparatus for receiving radio signal according to claim 25, wherein said tunable RF processing module includes:
at least one RF filter, for filtering the received radio signal in the corresponding frequency band according to said control signal;
at least one LNA, for amplifying the filtered signal to output an amplified and filtered signal in the corresponding frequency band.

27. The apparatus for receiving radio signal according to claim 24, further comprising:
a tunable RF processing module, for receiving the output signal in the corresponding frequency band from said back-end band switching unit according to said control signal, and filtering and amplifying the output signal in the corresponding frequency band.

28. The apparatus for receiving radio signal according to claim 27, wherein said tunable RF processing module includes:
at least one RF filter, for filtering the output signal in the corresponding frequency band from said back-end band switching unit, according to said control signal;
at least one LNA, for amplifying the filtered signal to output an amplified and filtered signal in the corresponding frequency band.

29. An RF filtering and amplifying method, comprising steps of:
filtering the received radio signal level by level;
amplifying the filtered signal to output an amplified and filtered signal; generating a control signal according to the frequency band of the received radio signal;
filtering the radio signal in the receive frequency band level by level according to the control signal;
amplifying the filtered signal in the corresponding frequency band according to the control signal, so as to output an amplified and filtered signal in the corresponding frequency band.

30. An RF filtering and amplifying method, comprising steps of:
(a) generating a control signal according to the frequency band of the received radio signal;
(b) switching the received radio signal in the corresponding frequency band to the RF processing sector in the corresponding frequency band according to the control signal;
(c) filtering and amplifying the radio signal in the corresponding frequency band, to output an amplified and filtered signal in the corresponding frequency band;
(d) switching to the RF processing sector in the corresponding frequency band according to the control signal, to receive the amplified and filtered signal in the corresponding frequency band.

31. The method according to claim 30, wherein step (c) includes:
filtering said received radio signal level by level;
amplifying the filtered signal to output an amplified and filtered signal.
